(19) United States
(12) Patent Application Publication
(10) Pub. No.: US 2006/0195603 A1
(43) Pub. Date: Aug. 31, 2006

(54) Network traffic control system

(76) Inventor: Dongchul Shin Seungdong Lee, 425 SGOKDONG (KR)

Correspondence Address: Siemens Corporation;Intellectual Property Department, 170 Wood Avenue South, Iselin, NJ, 08830, US

(21) Appl. No.: 10/552,882

(22) PCT Filed: Apr. 21, 2004
(86) PCT No.: PCT/EP04/50575

§ 371 Date: Oct. 13, 2005

(30) Foreign Application Priority Data
Apr. 21, 2003 (KR) 10-2003-0025223

(51) Int. Cl. G06F 15/16

(52) U.S. Cl. 709/232

(57) ABSTRACT

A network traffic control system, where traffic can be controlled by allowing a rate limit for each of the communication ports to be arbitrarily set, even in the case that its switching processor does not support the rate limiting capability. The network traffic control system in accordance with the present invention comprises: a switching processor, including a plurality of ports connectable to a network line and packet counter registers for storing counting infon-nation on packets ingressed and egressed through the plurality of ports, for controlling ingress and egress packet traffic volume for each of the plurality of ports in response to an input traffic control command; and a controller for registering, as a user value, traffic volume for each of the plurality of ports in an internal register, the traffic volume being inputted through a data input unit, and for comparing a user value for each of the plurality of ports with a value in a respective one of the packet counter registers for each port so as to output the input traffic control command for each port to the switching processor.

### BRIEF DESCRIPTION OF THE DRAWINGS

FIG. 1 shows a block diagram of a typical network traffic control system.

FIG. 2 shows a block diagram of a network traffic control system in accordance with an embodiment of the present invention.

FIG. 3 shows a token bucket used for shaping the ingress traffic of an individual port

FIG. 4 shows a token bucket used for shaping the aggregate ingress traffic of two ports

### DISCLOSURE OF THE INVENTION

### OBJECTIVE OF THE INVENTION

### TECHNICAL FIELD AND BACKGROUND ART

The present invention relates to a network traffic control system, and more particularly, to a network traffic control system having a switching processor where traffic can be controlled by allowing a rate limit for each of the communication ports to be set, even in the case that the switching processor does not support the rate limiting capability.

Due to an increase in the use of various network applications, such as Internet-based network applications, interest in computer networks is ever growing. With the growing interest in computer networks, the technologies dedicated to controlling the traffic conditions of terminals interconnected on the network have received wide attention. Those kinds of technologies are called “network traffic control technologies” and a system embodying such technologies is called a “network traffic control system.”

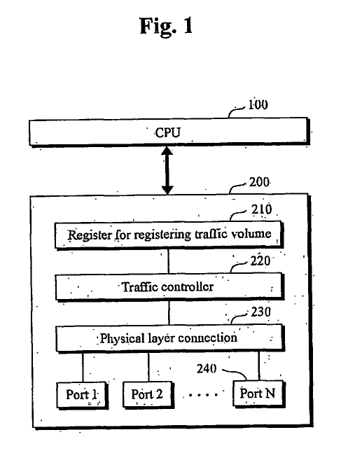

As shown in FIG. 1, a typical network traffic control system generally includes switching processor 200 for switching packets transmitted between computer terminals on the network and central processing unit (CPU) 100 for setting and controlling various parameters (for example, traffic volume for each port), which must be set for switching processor 200 to normally operate. Switching processor 200 includes register 210 for registering traffic volume for each port, traffic controller 220 (also referred to as a “port manager” by some manufacturers) for controlling traffic volume for each port, and physical layer connection (PHY) 230. Traffic controller 220 of switching processor 200 adjusts traffic volume within an allowable maximum of traffic volume for each port that is registered in register 210. The function of setting traffic volume for each port in switching processor 200, as mentioned above, is called “rate limiting.”

Some problems are encountered with rate limiting. In case the traffic volume is limited in advance, packets must be transmitted in such a way that the total traffic volume of the packet transmission is below the traffic volume limit. Accordingly, if the traffic volume of the transmission of all the packets is expected to exceed the traffic volume limit, traffic controller 220 forces a portion of the packets to be unnecessarily dropped, where that portion of the packets, if transmitted, would generate additional traffic volume that is over the traffic volume limit. This would lead to loss of transmission data or control data, which in turn results in a delay in data transmission.

Another problem associated with rate limiting is that most of the manufacturers of switching processor 200, which supports the rate limiting capability, preset the unit of setting ingress and egress traffic volume to, for example, a unit of 8 M. Therefore, from the standpoint of customers of the switching processor, the traffic volume cannot be set to a smaller unit, for example, a 1 M unit, in consideration of a specific need from a particular customer group.

A problem also arises from adopting the switching processor without the rate limiting capability. For such a switching processor, the allowable traffic volume for each port is preset to a fixed value by the manufacturer, which also makes it difficult to set diversely or adjust traffic volume in accordance with needs from a particular customer group.

### TECHNICAL OBJECTIVE OF THE INVENTION

An objective of the present invention is to provide a network traffic control system having a switching processor where the user can arbitrarily adjust traffic volume for each of the communication ports that is controlled by the switching processor.

Another objective of the present invention to provide a network traffic control system having a switching processor for freely setting and controlling traffic volume for each of the communication ports within an allowable range of traffic volume that is supported by the switching processor, where the switching processor does not support the rate limiting capability.

### DISCLOSURE OF THE INVENTION

In accordance with an aspect of the present invention, an apparatus for controlling traffic over a network is provided, which comprises: a switching processor, including a plurality of ports connectable to a network line and packet counter registers for storing counting information on packets ingressed and egressed through the plurality of ports, for controlling ingress and egress packet traffic volume for each of the plurality of ports in response to an input traffic control command; and a controller for registering, as a user value, traffic volume for each of the plurality of ports in an internal register, the traffic volume being inputted through a data input unit, and for comparing a user value for each of the plurality of ports with a value in a respective one of the packet counter registers for each port so as to output the input traffic control command for each port to the switching processor. The input traffic control command may be a control command that enables the packets ingressed or egressed through each port to be queued, dropped, or paused.

As described above, in accordance with the present invention, traffic volume ingressed and egressed through each of the ports of the switching processor can be adaptively controlled to be within an allowable range of traffic volume as preset by a control unit, so that the user can arbitrarily adjust traffic volume for each port, thereby achieving traffic volume control.

The allowable range of traffic volume can be represented by a user value for a maximum traffic volume. This user value is entered in a register so that it can be compared with a respective value for the traffic volume, the respective value being written in a packet counter register. In case the respective value exceeds the user value a traffic control command to the switching processor may be issued.

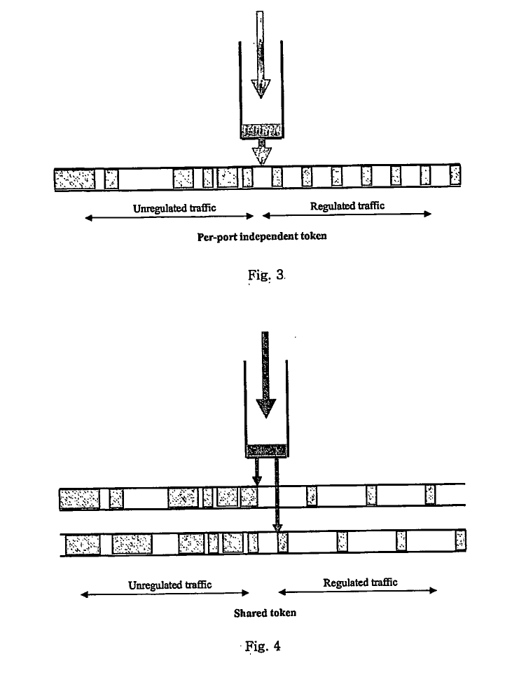

The invention is not limited to traffic control for individual ports. It also covers situations or configurations where a number or plurality of ports are aggregated or bundled to cooperate. The aggregation of links or ports (also called port bundling) is widely used for redundancy and bandwidth expansion. For such a configuration it is desirable to set a limit for the maximum traffic for the aggregate traffic ingressed or/and egressed via the plurality of ports. Traffic control of such a plurality of ports can be realized by means of a token bucket. The token bucket concept a common queuing technique. A typical algorithm is that for every second of time, a token is saved. If a token is sent, one of these tokens is destroyed. If no packets are being sent, tokens start to accumulate, which can be used later to burst packets. FIG. 3 shows a token bucket which is used for shaping or regulating traffic. As shown in FIG. 4 this concept can be extended to two or more ports. The plurality of ports share the same token bucket. If one of the ports has little traffic, the other ports of the plurality of ports can transport (ingress or egress) more traffic adaptively by utilizing unused tokens. This concept of token bucket sharing can be applied to queuing, dropping and pausing.

Simultaneous control of aggregated traffic relating to a plurality of ports and traffic relating to separate individual ports is possible, too. As a rule, a multiplicity of ports may be grouped in any possible way. The corresponding traffic may be controlled by assigning a traffic limit to any plurality of ports and any individual port corresponding with the grouping of the multiplicity of ports.

An efficient mechanism for dropping packets is given by using frame-size pinching. The requirement for a dropping mechanism used in conjunction with traffic control of individual ports (or different pluralities of ports) is that it should control only ingress traffic without interfering with egress traffic and it should be port-by-port controllable. Frame-size pinching consists of setting the parameter for the maximum frame size (max-frame-size parameter) to a number smaller than the minimum supported frame size. For instance, networks based on the Ethernet standard require a minimum frame size of 64 bytes. By setting the max-frame-size parameter to a value smaller than 64 bytes, packets smaller than 64 bytes are dropped because they do not comply with the limit set by the Ethernet standard and packets equal to 64 bytes or larger are dropped due to the maximum frame size limit. An embodiment of the present invention will now be described in detail with reference to the accompanying drawings. In case that a detailed description for the well-known parts or elements of the invention, if incorporated herein, is believed to render the essence of the invention ambiguous, it will be omitted for clarity.

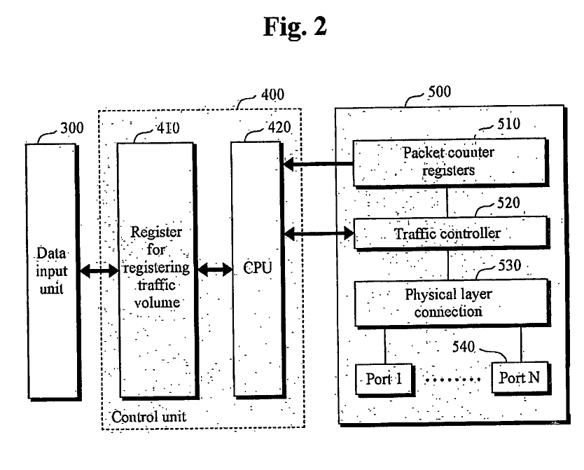

Referring to FIG. 2, a network traffic control system is shown in accordance with an embodiment of the present invention. As shown in FIG. 2, data input unit 300 receives ingress and egress packet traffic volume for each of ports 540 from the operator. A conventional data input device, such as a keyboard, a mouse, and the like, may be used for data input unit 300. The traffic volume inputted from data input unit 300 is registered in a register 410 as a user value. Register 410 and central processing unit (CPU) 420, which will be described below, operate to control switching processor 500. Register 410 and CPU 420 may be integrated onto a single chip.

CPU 420 compares a user value for each port as registered in register 410 with a value in a respective one of packet counter registers 510 for the respective port. Then, CPU 420 issues a traffic control command for each of the ports to switching processor 500, thereby controlling traffic volume for each port. Note that the traffic control command is a control command that enables the packets ingressed or egressed through each port 540 to be queued, dropped or paused.

Switching processor 500 comprises packet counter registers 510, traffic controller 520, physical layer connection 530, and plurality of ports 540. Switching processor 500 controls traffic volume for each port 540 under the control of control unit 400.

Each of ports 540 is intended to couple a physical medium, i.e., a communication line, which constitutes the network, to switching processor 500. Packet counter registers 510 are used to register traffic volume, i.e., the number of packets currently ingressed and egressed through each port 540. The number of packets for each port, as registered in packet counter register 510, is read by CPU 420.

Traffic controller 520 counts the number of ingress and egress packets for each port 540 to write it in packet counter register 510. Also, traffic controller 520 controls ingress and egress packet traffic volume for each port 540, responsive to the traffic control command from CPU 420. For example, upon receiving from CPU 420 a drop command for controlling traffic volume, traffic controller 520 performs packet control to cause a portion of the packets ingressed through each port 540 to be dropped and then egressed. Note that the drop command may be generated when the ingress packet traffic volume for each port 540 exceeds the user value registered in register 410. Physical layer connection 530 encodes data from a data link layer, which is in the upper level in network hierarchy, and communicates the encoded data with a physical layer medium-dependent part (PMD), which is in the lower level.

The operation of the network traffic control system in accordance with the present invention will now be described. First, the operator or user sets the ingress and egress packet traffic volume for each of ports 540, which is provided in switching processor 500, by using data input unit 300. In this case, the operator or user may arbitrarily set the ingress and egress packet traffic volume such that it falls within the range defined by an allowable maximum traffic volume for each port 540. The operator may adjust, according to his specific traffic volume requirements, traffic volume on a smaller unit than is used by the conventional switching processor such that, for example, 256 Mbit of ingress traffic is allocated to port #1 and 230 Mbit to port #2. Once traffic volume for each port 540 is set in the way described above, the traffic volume as set is registered in register 410 as a user value.

If packets are switched and transmitted through each port 540 by switching processor 500, traffic controller 520 counts the number of ingress or egress packets for each port 540 to write it in packet counter register 510. Thereafter, CPU 420 reads the value (number) from each of packet counter registers 510 and compares it with the user value set for the respective port 540. CPU 420 then issues a control command for controlling traffic volume for each port 540 based upon the result of the comparison.

For example, when the real-time egress packet traffic volume for a particular port exceeds the user value as registered, CPU 420 issues a drop command to traffic controller 520. In response to the drop command, traffic controller 520 forces the packet traffic volume egressed through the port to be dropped, thereby limiting the egressed packets to be within the range as registered. If the ingress packet traffic volume for a particular port is below the user value as registered, CPU 420 issues a queuing command to traffic controller 520. In response to the queuing command, traffic controller 520 queues the ingress packets into the memory (not shown) as far as the capacity of the memory allows. On the other hand, if the ingress packet traffic volume is expected to exceed the user value as registered, CPU 420 issues a pause command to traffic controller 520. Then, traffic controller 520 transmits the pause command to the counterpart (transmitting) terminal so that the ingress packets are temporarily paused.

As described above, in accordance with the present invention, the operator or user sets, as a user value, packet traffic volume for each of the ports in control unit 400 by using the data input unit such that the traffic volume for each port can be controlled on the basis of the preset user value. Therefore, the present invention can support the rate limiting capability, regardless of the availability in the switching processor of such rate limiting capability, and allows the user to adjust traffic volume on an arbitrary small unit.

### EFFECTS OF THE INVENTION

As described above, in accordance with the present invention, the user of the switching processor can advantageously adjust traffic volume for each of the ports, which is controlled by the switching processor, in an arbitrary manner, thereby achieving control over the same. Further, the network traffic control system of the present invention can advantageously be used to allow the user to freely set and control the traffic volume for each of the ports within the range defined by a maximum traffic volume available in each port of the switching processor, which does not support the rate limiting capability.

While the present invention has been described and illustrated with respect to an embodiment of the present invention, it will be apparent to those skilled in the art that variations and modifications are possible without deviating from the broad principles and teachings of the present invention, which should be limited solely by the claims appended hereto.

1. An apparatus for controlling traffic over a network, comprising:
a switching processor, including a plurality of ports connectable to a network line and packet counter registers for storing counting information on packets ingressed and egressed through said plurality of ports and for controlling ingress and egress packet traffic volume for each of said plurality of ports in response to an input traffic control command; and
a controller for registering, as a user value, traffic volume for each of said plurality of ports in an internal register, said traffic volume being inputted through a data input unit, and for comparing a user value for each of said plurality of ports with a value in a respective one of said packet counter registers for said each port so as to output said input traffic control command for said each port to said switching processor.

2. An apparatus for controlling traffic over a network, comprising:
a switching processor, including a plurality of ports connectable to a network line and a packet counter register for storing counting information on packets ingressed and/or egressed through said plurality of ports and for controlling ingress and/or egress packet traffic volume for said plurality of ports in response to an input traffic control command; and
a controller for registering, as a user value, traffic volume for said plurality of ports in an internal register, said traffic volume being inputted through a data input unit, and for comparing a user value for said plurality of ports with a value in a respective one of said packet counter registers for said plurality of ports so as to output said input traffic control command for said plurality of ports to said switching processor.

3. The apparatus of claim 2, wherein said ingress and/or egress traffic volume is controlled via a token bucket, which is shared between the ports of said plurality of ports.

4. The apparatus of one of the claims 1 to 3, wherein said input traffic control command is a control command that enables said packets ingressed or egressed through said each port to be queued, dropped, or paused.

5. A method for controlling a traffic volume ingressed or egressed via a port or a plurality of ports of a switching processor, comprising the steps of
entering a user value for a maximum traffic volume,
comparing said user value with a respective value for said traffic volume, said respective value being written in a packet counter register, and issuing a traffic control command to said switching processor.

6. The method of claim 5, wherein said traffic volume relates to a plurality of ports and said traffic volume is controlled via a token bucket, which is shared between the ports of said plurality of ports.

7. The method of claim 5 or 6, wherein a packet is dropped by setting the frame size parameter smaller than the minimum Ethernet frame size.
